(19) United States
(12) Patent Application Publication
(10) Pub. No.: US 2014/0049127 A1
(43) Pub. Date: Feb. 20, 2014

(54) Dynamically Induced and Reactive Magnetic Hysteresis Applications and Methods

(71) Applicant: Elberto Berdut-Teruel, San Juan, PR (US)

(72) Inventor: Elberto Berdut-Teruel, San Juan, PR (US)

(21) Appl. No.: 14/034,088

(22) Filed: Sep. 23, 2013

Related U.S. Application Data
(63) Continuation-in-part of application No. 13/479,410, filed on May 24, 2012.

(51) Int. Cl. H02K 7/14

(52) U.S. Cl. CPC H02K 7/14
USPC 310/80

(57) ABSTRACT

A dynamically induced magnetic hysteresis apparatus is described which allows efficient adjustable power coupling without direct mechanical attachment or linking. Adjustment of spatial and penetration gaps are adjusted to vary the ratio of rotation.

### CROSS-REFERENCE TO RELATED APPLICATIONS

This application is a continuation-in-part of pending U.S. application “Dynamically Induced and Reactive Magnetic Hysteresis Applications and Methods”, Ser. No. 13/479,410 the disclosure of which is incorporated herein by reference in its entirety.

### PATENTS CITED

The following documents are incorporated by reference in their entirety, Berdut U.S. Pat. No. 5,615,618 “Orbital and modular motors using permanent magnets and interleaved iron or steel magnetically permeable members”, and Berdut U.S. application Ser. No. 12/838,955 “Electrical generator having critical Non-Ferrous components”.

### TECHNICAL FIELD

The present invention generally relates to the phenomena of dynamically induced and reactive magnetic hysteresis (DIMH), and in particular to its applications for levitation and power transfer within coupled mechanical systems in both vertical and horizontal applications.

### BACKGROUND

The phenomena of power couplings and transfer using permanent and electromagnets are well known. In particular, Toukola (U.S. Pat. No. 5,600,194) teaches a magnetic hysteresis clutch using ferrous or ferromagnetic materials. Johnson (U.S. Pat. No. 7,449,807) teaches a magnetic transmission using permanent magnets matched in a ‘magnetic sprocket’ drive. Lamb (U.S. Pat. No. 5,909,073) teaches a magnetic coupler having an electromagnetic conductor rotor.

The above have in common the use of ferrous materials in combination with permanent magnets or electromagnets. The use of electromagnets on non-ferrous materials allows for the dynamically induced and reactive magnetic hysteresis transition of the induced magnetic field with no moveable parts. However, when using permanent magnets, the advantages have been limited by the need to have the permanent magnets create the transition via motion.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

In one aspect the invention is about a dynamically induced magnetic hysteresis apparatus comprising one or more electric motors, each said motor powering a belt hub, a belt having one or both surfaces covered with alternating N-pol and S-pol permanent magnets and a straight metal roadway whose surface is parallel to the surface of said belt, yet not in contact with said belt, and located within the magnetic field generated by the linear translation of said belt permanent magnets. In another aspect the one or more electric motors that provide magnetic levitation are each comprised of an armature and rotor assembly, each said armature being arc-shaped with one opening along its periphery and a plurality of inductive elements placed solely inside the periphery of said arc's partial circumference and a circular rotor having a width equal or smaller than that of said arc-shaped armature and housed completely within said arc-shaped armature, said rotor having a plurality of pairs of alternating polarity permanent magnets along its periphery, with at least one pair of said permanent magnets outside the magnetic field of the inductive elements in said arc-shaped armature. In yet another aspect said straight metal roadway is comprised primarily of ferrous metals, or is comprised primarily of non-ferrous metals or is formed from all or portions of ferrous, non-ferrous and other phenolic materials.

In another aspect, the one or more electric motors that provide magnetic levitation are each comprised of an armature and rotor assembly, said armature being arc-shaped with one opening along its periphery and a plurality of inductive elements placed solely inside the periphery of a said arc's partial circumference, and a circular rotor housed partially within said arc-shaped armature, said rotor having a plurality of pairs of alternating polarity permanent magnets along its periphery, with at least one pair of said permanent magnets outside the magnetic field of the inductive elements in said arc-shaped armature. In yet another aspect, said straight metal roadway is comprised primarily of ferrous metals, or primarily of non-ferrous metals or is formed from all or portions of ferrous, non-ferrous and other phenolic materials.

In one aspect, the invention is about a dynamically induced magnetic hysteresis power transfer coupler comprising, one or more driven shafts, each said shaft rotating along its central axis and each connected to an inducing rod drive, each said rod drive having along its periphery a pair of complementary polarity permanent magnets, one or more circular driven plates, each said driven plate separated from said driven shafts external surface by a fixed distance, mechanical means for adjusting the depth of each said rotating shaft along the radius of said circular driven plate. In yet another aspect, the mechanical means for adjusting said depth of each rotating shaft along the radius of said circular driven plate does so dynamically.

Other features and advantages of the present invention will become apparent upon examining the following detailed description of an embodiment thereof, taken in conjunction with the attached drawings.

### BRIEF DESCRIPTION OF THE DRAWINGS

FIGS. 1A and 1D show illustrations of an open armature dynamically induced and reactive magnetic hysteresis engine according to exemplary embodiments of the invention.

FIGS. 2 and 3 show illustrations of a flat plate dynamically induced and reactive magnetic hysteresis transfer apparatus, according to exemplary embodiments of the invention.

FIG. 4 shows an illustration of a multi-axis enhanced dynamically induced and reactive magnetic hysteresis transfer apparatus, according to an exemplary embodiment of the invention.

FIGS. 5-7 show illustrations of a linearly elongated enhanced dynamically induced and reactive magnetic hysteresis transfer apparatus, according to exemplary embodiments of the invention.

### DETAILED DESCRIPTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein; this reference does not constitute an admission that any of these documents form part of the common general knowledge in the art.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

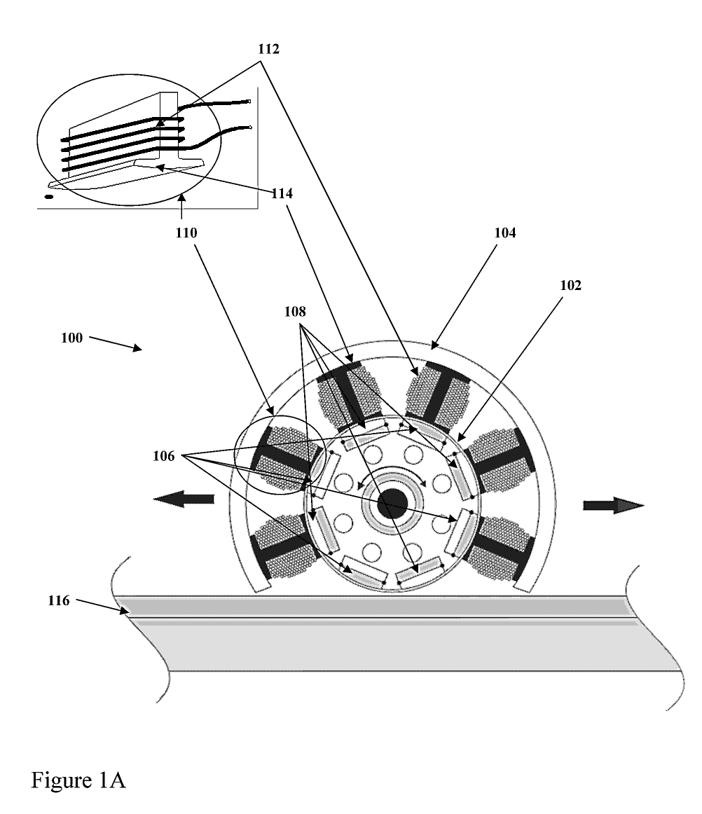

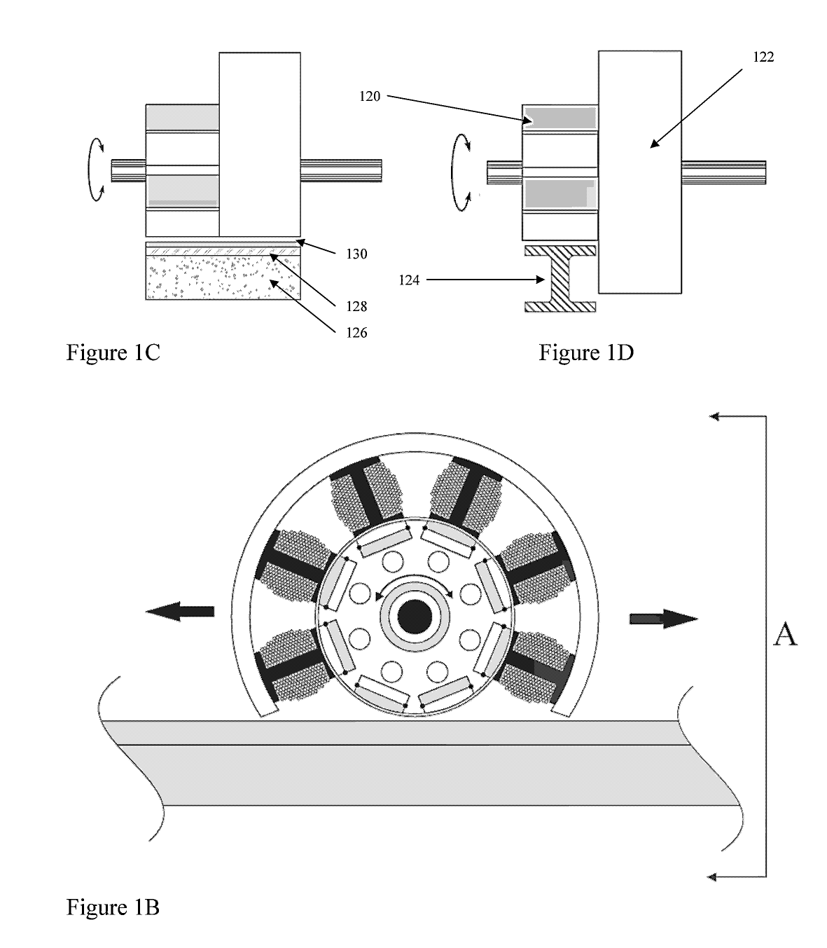

Referring to FIG. 1, we see an embodiment 100 capable of dynamically induced and reactive magnetic hysteresis (DIMH) on a ferrous or non-ferrous metal or composite. In it, we see a rotor assembly 102 having permanent magnets designed to fit within an armature or stator 104. In one embodiment, the armature is traditional and symmetric, fully surrounding the rotor. In an alternate embodiment, the armature (as shown in FIG. 1A) has at least one opening, with less inductive elements within it than the number of magnetic (or electromagnetic) elements in the rotor, making it asymmetric in shape. Note that the rotor will rotate as a function of the current flow into the inductive elements, allowing it to rotate in both directions.

The opening in the armature allows for the rotor to be closer to the track 116. In either embodiment, the armature is connected mechanically to a housing that also is connected mechanically to the rotor. One embodiment is a molded housing capable of mechanically affixing the rotor central axle to said housing. Such a molding may be plastic, metal (both ferrous or non-ferrous), wood, etc.

In one embodiment, the permanent magnets within the rotor assembly 102 are comprised of one or more pairs of North polarity (N-pol 106) and South polarity (S-pol 108) permanent magnets placed around a single rotating disk. Pairs of permanent magnets may be used. In that case, the area of the magnets need not be similar, but would be optimal as long as the area of their opposite pole is significantly similar.

Note that in defining North or South polarity on a permanent magnet, we are using the “North” pole of a magnet as defined by the National Bureau of Standards (NBS) convention. Said convention is based on the following: “The North Pole of a magnet is that pole which is attracted to the geographic North Pole. Therefore, the North Pole of a magnet will repel the north seeking pole of a magnetic compass.” Its significant opposite is the South Polarity.

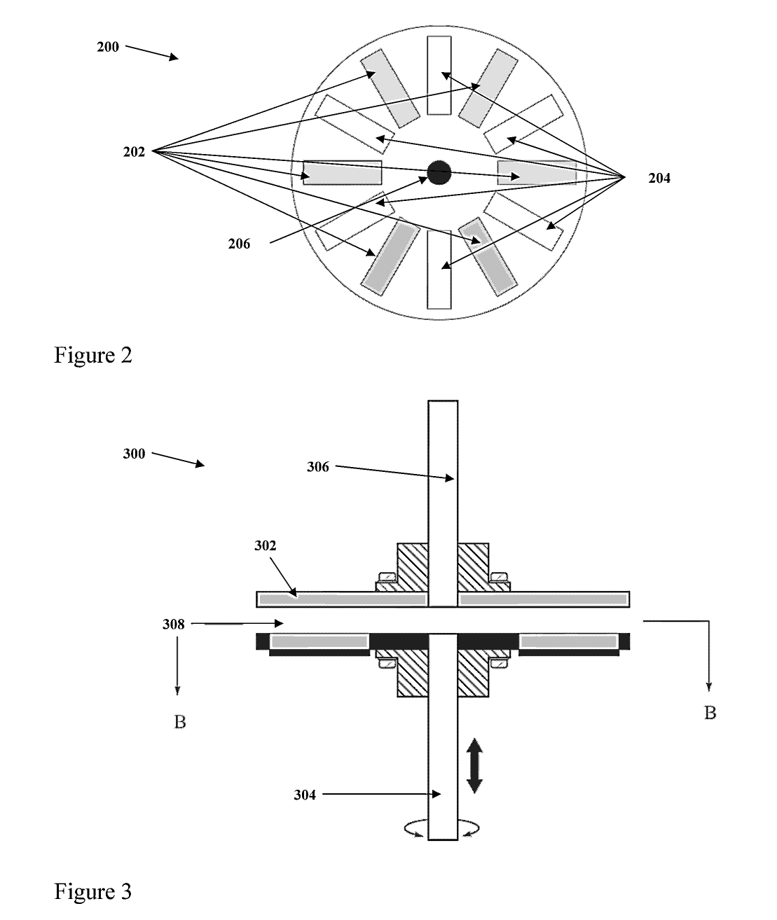

In an alternate embodiment, the rotor's magnets are electromagnets. Like the ones in the armature, they are powered by either a commutation circuit, or directly. In yet another embodiment, the magnets (FIG. 2) within the armature are electromagnetic, and those outside (and above the rail) are permanent magnets.

In one embodiment, the Armature or Stator 104 assembly is unique in that it has an open area. The bobbins or inductive elements 110 are placed in the stator, and as current flows through its windings 112, used to generate a magnetic field. This magnetic field generated by these inductive elements interacts with that of the permanent magnets in the rotor (106, 108), inducing a moment of inertia and the rotation of the rotor 102. Note that in one embodiment, the magnets within the rotor could also be electromagnets, turned on/off via a commutator.

Each individual inductive element 110 is comprised of an assembly of materials. The windings 112 may be comprised of all or parts of ferrous (or ferromagnetic) materials (such as iron coils), as well all or parts of non-ferrous metals (such as copper and aluminum) formed into a single strand of wire. In one embodiment, each wire is individually insulated and wound around a bobbin 114 which may have certain ferrous components, but is principally or completely made of a non-ferrous and/or non-magnetic material.

The possible materials for the bobbins 110 may be comprised of ferrous as well as non-ferrous metals (again, copper, stainless steel, aluminum, lead), phenolic materials, all non-ferrous polymers (including amorphous as well as semi-crystalline plastics), ceramics, wood, fiberglass, carbon fiber composites, epoxy composites and others. Some of the trade names for the above materials include PromoSpire, Torlon, AvaSpire, Amodel and their competitors.

The rotation of the rotor 102 (again, in either direction, as is the case with all drive rotors in this application) has the consequence of subjecting the roadway, channel or rail 116 to the dynamically induced and reactive magnetic hysteresis phenomena. As with the bobbins 110, the rail or roadway 116 may also be comprised of both ferrous and non-ferrous materials. In addition, composite sandwich structures are particularly desired for aesthetic and/or architectural reasons. In the case of a horizontal structure, you could make a railway bed with concrete as an exterior, and metal (again, either ferrous, non-ferrous or itself also a sandwich) interior. In the case of a window-washer support structure, the metal portions could be hidden behind the building's facade.

Through the control of the rate and direction of rotation of the rotor 102, a number of variables may be controlled. When the rotor 102 is not subject to any energy from the bobbins 110, it stops. When the rail 116 has a ferrous metal component, this results in the traditional attraction, effectively securing the assembly 100 to the rail or roadway 116. This would be advantageous as a permanent or “parking” brake in either horizontal or vertical situations. It could also act as an emergency brake (especially if the outside of the rotor 102 had a protective cover made of plastic or even non-ferrous metals).

When the roadway has a ferrous material component, removing the rotation from the rotor 102 will cause the traditional magnetic “stiction” to occur, effectively securing the assembly 100 to the roadway. In horizontal situations, this may act as a parking brake. In vertical situations the rotor would prevent vertical displacement. In an elevator embodiment, removing the rotation of the rotor 102 would act as an optimal “floor” stopper when the elevator is opened at a floor and waiting, or in emergency situations.

When a particular direction of rotation of the rotor 102 is induced and reactive, the reaction is dependent on the roadway material. If a purely non-ferrous metal was used (say copper or aluminum), there will be no reaction until the rotation of the rotor 102 induces the creation of an induced and reactive magnetic field within the non-ferrous metal. If there roadway is made of a ferrous metal exclusively, this induced field will also be created, albeit somewhat faster. Composite structures having a non-ferrous exterior with a ferrous interior (a particularly weather resistant combination) will have a combination of both.

The amount and direction of rotation of the rotor 102 is driven by the order with which the magnetic field is induced into the bobbins 110, something well known to electric motor designers. Through this, both the rate and direction of rotation of the rotor is controllable. In all cases, the rotor 102 magnetic field will interact with the roadway's 116 inducing a reflective moment on the rotor/stator assembly 100. If the assembly is not tied down, it will move.

In addition to the translational force described above, the induced and reactive magnetic field on the roadway 116 will cause a levitation effect due to the component of the magnetic field that is of equal polarity. This levitation will certainly assist in the displacement of the assembly attached to the assembly 100. Note that the induced and reactive magnetic field also is capable of generating heat, so in one embodiment the assembly may be used to heat a metal piece or extrusion by keeping the assembly 100 stationary or fixed, and moving the roadway or rail under it until a desired temperature is reached.

In one embodiment, the rotor 102 has similar width to that of the armature 104. In an alternate embodiment FIG. 1B, the rotor 120 is wider than the armature 122 (on either or both sides), having the portion of the rotor 120 within the armature providing the rotation moment (through the action of the inductive elements in it), with the magnets in the rotor 120 (both inside and outside the armature in varying degrees) providing the levitation and motion interaction with the rail 116. In one embodiment, this allows for the armature to be symmetric. In an alternate embodiment, the armature is still asymmetric.

The rail or roadway with which the system interacts varies. In one embodiment, it is a rail 124 made of ferrous, non-ferrous or a combination thereof. In an alternate embodiment, it is a roadway comprised of a combination of layers. These layers may include concrete, rock or such other suitable substrates 126, a ferrous layer 128 comprised of ferrous materials such as steel, iron and others, and a non-ferrous layer 130 comprised of non-ferrous materials such as aluminum or copper.

The induced magnetic hysteresis phenomena described above is also useful in the mechanically uncoupled or de-linked transmission of power, as is the case in transmissions, torque converters and other power transfer adapters. It is particularly suited to mechanically uncoupled transfers, where the desire is to transfer power, but survive sudden stops, as is the case of automatic transmissions. FIG. 2 illustrates a permanent magnetic field dynamic inducement transfer means, comprised of a plate 200 to be used in inducing such a dynamic magnetic hysteresis according to an exemplary embodiment of the invention.

In one embodiment, the transfer means are comprised of such a plate formed from any number of materials capable of having a rigid form. These materials include metals (both ferrous and non-ferrous), plastics (including thermoplastics and thermosetting polymers), carbon composites, and any number of cement mixtures (including concrete and others), or combinations thereof.

In one embodiment, a plurality of alternating permanent magnets are mounted on the surface of said plate. In an alternate embodiment, they are placed within the width of said plate, or below the surface. These magnets may be comprised of a number of rare earth materials, including neodymium, ceramic materials or mixtures thereof. Said magnetic elements may have the shapes of plates, cylinder, hexagonal, octagonal, square and other forms. As described before, the alternating of North 202 and South 204 polarities (or conversely N-S and S-N magnets facing out with a predominant fascia polarity) will result in an induced and reactive magnetic field once the plate begins to rotate around its axis 206.

In one embodiment FIG. 3, the transfer of power is accomplished by the close spatial matching of the inducement plate 200 to one or more receiving plates 302. As above, the rotation of the shaft 304 (corresponding to the axis 206), provides an induced and reactive field that will generate a moment of inertia on the receiving plate(s) 302 which proceeds to rotate the driven axle or shaft 306. While both plates (transfer and receiving) may be any size or shape, in one embodiment they are similarly sized and shaped.

In operation, the dynamically induced and reactive magnetic field on the receiving plate 302 operates as the torque converter in a hydraulic transmission, allowing for the complete stoppage of the receiving shaft or axle 306 while the driving shaft or axle 304 continues to rotate. Instead of using a fluid, the operation occurs through the interaction of the magnetic fields, the one from the permanent magnets, the secondary one from the induced and reactive magnetic hysteresis.

There is an amount of slippage (where the revolutions of the driving axle 304 are more than those of the driven axle 306). This slippage is a function of the distance of the gap 308 between the plates 200, 302. In one embodiment, a device is envisioned with a fixed gap. In an alternate embodiment, an adjustable gap 308 is created by the movement of either the driving shaft 304 or the driven shaft 306, or both (whereas the depth adjustment along the axis 206 is defined as the Z direction in a traditional X-Y-Z Cartesian frame).

Notice that the gap distance does not have to be constant. In one embodiment, one or both axles may be equipped with X-Y flexibility, so that over time the rotation of one to the other will try to force the distance of the gap 308 to be relatively uniform. The above is ideal as a potential power transfer clutch or transmission in washing machines, dryers, vehicles and other such machines, particularly in applications such as electric vehicles (air, land and sea) where weight or the ability to reverse directions without undue strain are desired. In this form, the size of the space or gap 308 serves as an automatic transmission gear ratio box, by controlling the amount of ‘slip’.

While shown in an embodiment surrounded by air, these magnetic couplers may be immersed fluids or gases in order to remove heat (both from mechanical friction and from magnetic friction or slippage). This heat may be detrimental to the mechanical assembly, or it may be beneficial somewhere else in the vehicle. Such is the case in electric vehicles, where heat may be generated while the vehicle coasts as a free side benefit.

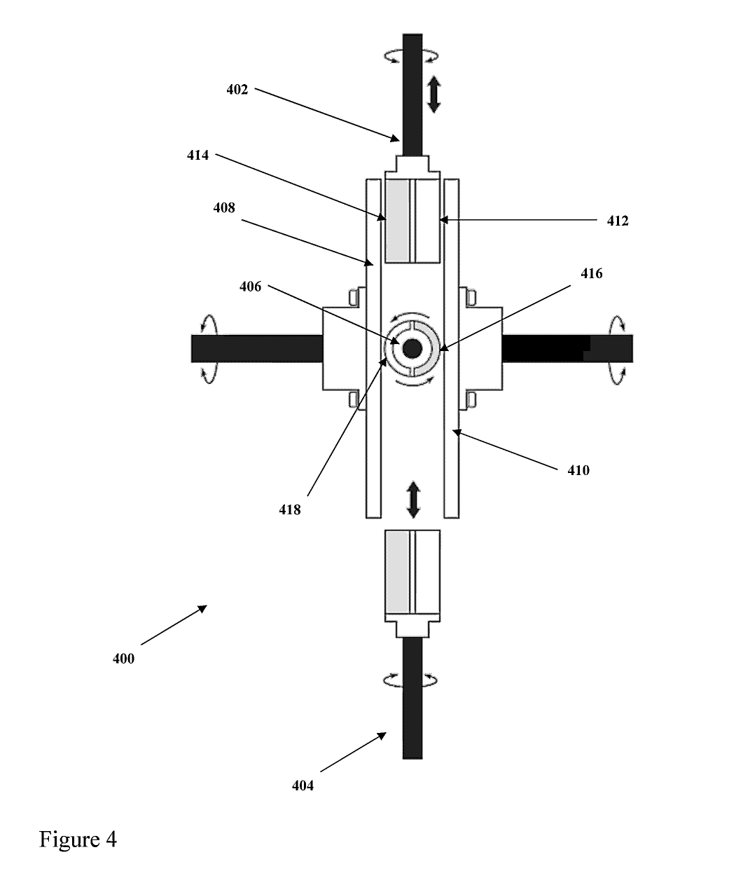

In another embodiment, the arrangement may be used to create orthogonal driving axles FIG. 4. In this exemplary embodiment, we see a system 400 where one or more driving cylinders or rods drives 402 (and optional driven rods 404, 406) are used to create a dynamically induced and reactive magnetic hysteresis field on one or more circular driven plates 408, 410. The driving rods (402, 404, 406) are comprised of cylinders with portions of their surfaces having a N-pol 418, and complementary portions having an S-pol 416, as described before (such as 402, having N-pol 414 and S-pol 412). Each rod is connected to a rod having its rotation axis or axle. The magnets use may be permanent, or electro-magnets.

The rotation of the driving rods (402, 404, 406) creates the alternating magnetic field required to induce the magnetic field on the driven plates 408, 410. The driven plates may be comprised of ferrous metals, non-ferrous metals, or composites comprising said metals and other phenolic materials. As before, the rods (402, 404, 406) are separated from the driven plates by a spatial gap. In one embodiment, the gap is similar in dimension, in an alternate embodiment, the separation is a fraction or multiplicity of one to the other.

In one embodiment, the depth of penetration (or position) of the driving rod(s) (402, 404, 406) is fixed, or at best adjustable during set-up. In an alternate embodiment, the depth of penetration (i.e. position) of each driving rod is adjustable on the fly, in order to operate as an automatic transmission that engages depending on the torque required by the driven plates. A combination of two of the systems 400 connected in cascade would be a superior all wheel drive power transmission media. In one embodiment, the distance between the driven plates 408, 410 is adjustable (either on the fly or at set-up).

In an alternate embodiment, one of the plates 408 is similar in construction to the plate 200 used in FIG. 2, becoming the primary driving plate for the system 400. This drive creates a DIMH field which will affect the other metallic disks (410) as well as rods (402, 404, 406). In one embodiment, the rods are built as shown (with portions of N-pol and S-pol permanent magnets along their surface), whereas in another embodiment they are made of the same metal as the driven disk 410.

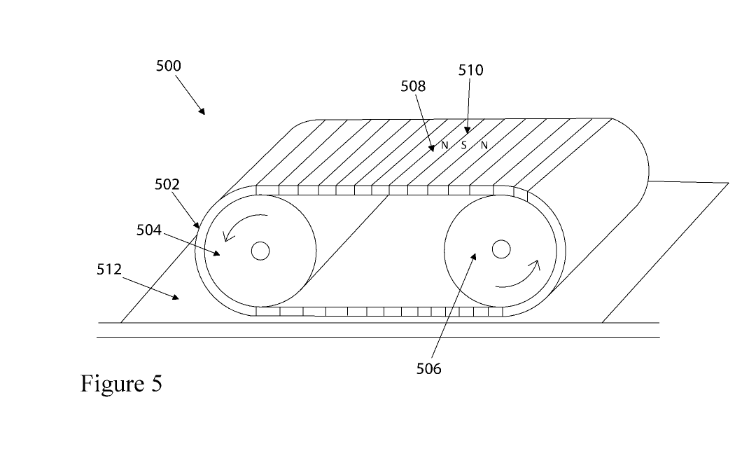

In an alternate embodiment, referring to FIG. 5, we see a linear belt implementation 500 of the system in FIGS. 1A-1D. A chain or belt 502 is emplaced as to be moving between two axis or hub 504, 506. These ends may be pulleys or motors, or pulleys connected to motors, so that the rotation of one or both causes the belt to move in a particular direction. One or both surfaces of said belt 502 are covered with alternating N-Pol 508, S-Pol 510 permanent magnets, so that the movement of the belt induces an effect on all or parts of the rails, roadway or track 512.

When said 512 has a ferrous metal component, this results in the traditional attraction, effectively securing the assembly 500 to the track This would be advantageous as a permanent or “parking” brake in either horizontal or vertical situations. It could also act as an emergency brake (especially if the outside of the belt 502 had a protective cover made of plastic or even non-ferrous metals). The rotation of the belt 502 (again, in either direction, as is the case with all drive rotors in this application) has the consequence of subjecting the roadway, channel, rail or track 512 to the dynamically induced and reactive magnetic hysteresis phenomena.

As in FIGS. 1A-1D, the track 512 may also be comprised of both ferrous and non-ferrous materials. In addition, composite sandwich structures are particularly desired for aesthetic and/or architectural reasons. In the case of a horizontal structure, you could make a railway bed with concrete as an exterior, and metal (again, either ferrous, non-ferrous or itself also a sandwich) interior. In the case of a window-washer support structure, the metal portions could be hidden behind the building's facade. Through the control of the rate and direction of rotation of the belt (through the motor driving the hub 504 or 506 or both, a number of variables may be controlled. When the belt 502 is not subject to any energy from the hubs 504, 506, it stops. When the track 512 has a ferrous metal component, this results in the traditional attraction, effectively securing the assembly 500 to the rail or roadway 512. This would be advantageous as a permanent or “parking” brake in either horizontal or vertical situations. It could also act as an emergency brake (especially if the outside of the belt 502 had a protective cover made of plastic or even non-ferrous metals). In horizontal situations, this may act as a parking brake. In vertical situations the rotor would prevent vertical displacement. In an elevator embodiment, removing the rotation of the belt 502 would act as an optimal “floor” stopper when the elevator is opened at a floor and waiting, or in emergency situations.

When a particular direction of rotation of the belt 502 is induced and reactive, the reaction is dependent on the roadway material. If a purely non-ferrous metal was used (say copper or aluminum), there will be no reaction until the rotation of the belt 502 induces the creation of an induced and reactive magnetic field within the non-ferrous metal. If there roadway is made of a ferrous metal exclusively, this induced field will also be created, albeit somewhat faster. Composite structures having a non-ferrous exterior with a ferrous interior (a particularly weather resistant combination) will have a combination of both.

In addition to the translational force described above, the induced and reactive magnetic field on the roadway 512 will cause a levitation effect due to the component of the magnetic field that is of equal polarity. This levitation will certainly assist in the displacement of the assembly attached to the assembly 500. Note that the induced and reactive magnetic field also is capable of generating heat, so in one embodiment the assembly may be used to heat a metal piece or extrusion by keeping the assembly 100 stationary or fixed, and moving the roadway or rail under it until a desired temperature is reached.

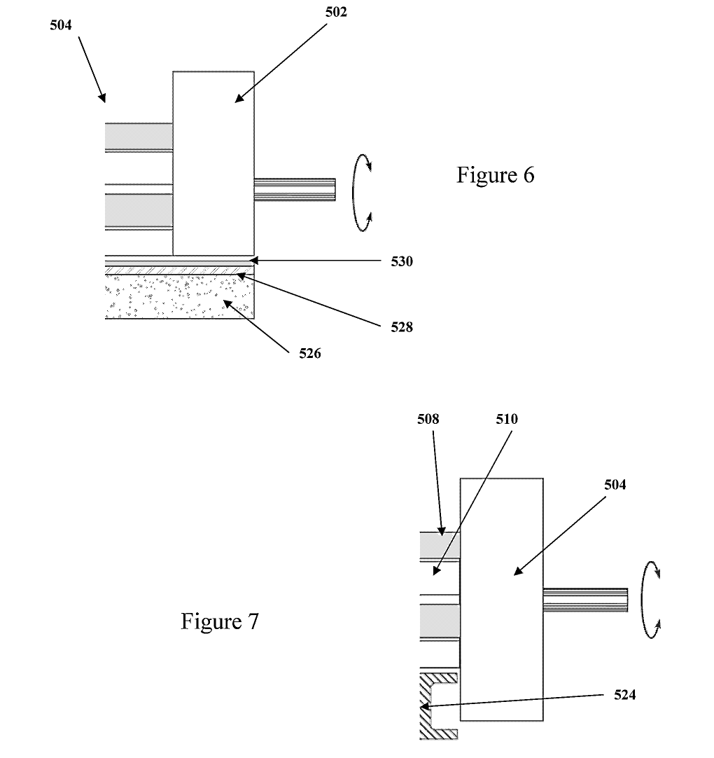

In one embodiment, the hubs belt 502 is similar in depth to the motor/rotor open-C configuration of FIG. 1A, so that side view (FIGS. 6-7) shows the belt 504 (formed of the alternating N-pol 508 S-pol 510). In one embodiment, it is a rail 524 made of ferrous, non-ferrous or a combination thereof. In an alternate embodiment, it is a roadway comprised of a combination of layers. These layers may include concrete, rock or such other suitable substrates 526, a ferrous layer 528 comprised of ferrous materials such as steel, iron and others, and a non-ferrous layer 530 comprised of non-ferrous materials such as aluminum or copper.

### CONCLUSION

In concluding the detailed description, it should be noted that it would be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

It should be emphasized that the above-described embodiments of the present invention, particularly any “preferred embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the forgoing description of embodiments.

I claim:

1. A dynamically induced magnetic hysteresis apparatus comprising;
one or more electric motors, each said motor powering a belt hub;
a belt having one or both surfaces covered with alternating N-pol and S-pol permanent magnets; and
a straight metal roadway whose surface is parallel to the surface of said belt, yet not in contact with said belt, and located within the magnetic field generated by the linear translation of said belt permanent magnets.

2. the apparatus of claim 1 further comprising;
the one or more electric motors that provide magnetic levitation are each comprised of an armature and rotor assembly;
each said armature being arc-shaped with one opening along its periphery and a plurality of inductive elements placed solely inside the periphery of said arc's partial circumference; and
a circular rotor having a width equal or smaller than that of said arc-shaped armature and housed completely within said arc-shaped armature, said rotor having a plurality of pairs of alternating polarity permanent magnets along its periphery, with at least one pair of said permanent magnets outside the magnetic field of the inductive elements in said arc-shaped armature.

3. the apparatus of claim 2 wherein;
said straight metal roadway is comprised primarily of ferrous metals.

4. the apparatus of claim 2 wherein;
said straight metal roadway is comprised primarily of non-ferrous metals.

5. the apparatus of claim 2 wherein;
said straight metal roadway is formed from all or portions of ferrous, non-ferrous and other phenolic materials.

6. the apparatus of claim 1 further comprising;
the one or more electric motors that provide magnetic levitation are each comprised of an armature and rotor assembly;
said armature being arc-shaped with one opening along its periphery and a plurality of inductive elements placed solely inside the periphery of a said arc's partial circumference; and
a circular rotor housed partially within said arc-shaped armature, said rotor having a plurality of pairs of alternating polarity permanent magnets along its periphery, with at least one pair of said permanent magnets outside the magnetic field of the inductive elements in said arc-shaped armature.

7. the apparatus of claim 6 wherein;
said straight metal roadway is comprised primarily of ferrous metals.

8. the apparatus of claim 6 wherein;
said straight metal roadway is comprised primarily of non-ferrous metals.

9. the apparatus of claim 6 wherein;
said straight metal roadway is formed from all or portions of ferrous, non-ferrous and other phenolic materials.

10. A dynamically induced magnetic hysteresis power transfer coupler comprising;
one or more driven shafts, each said shaft rotating along its central axis and each connected to an inducing rod drive, each said rod drive having along its periphery a pair of complementary polarity permanent magnets;
one or more circular driven plates, each said driven plate separated from said driven shafts external surface by a fixed distance;
mechanical means for adjusting the depth of each said rotating shaft along the radius of said circular driven plate.

11. the coupler of claim 10 wherein;
the mechanical means for adjusting said depth of each rotating shaft along the radius of said circular driven plate does so dynamically.
